(19) United States
(12) Patent Application Publication
(10) Pub. No.: US 2019/0201746 A1
(43) Pub. Date: Jul. 4, 2019

(54) GOLF BALL

(71) Applicant: Bridgestone Sports Co., Ltd., Tokyo (JP)

(72) Inventors: Hirotaka SHINOHARA, Chichibu-shi (JP); Takashi OHIRA, Chichibu-shi (JP)

(73) Assignee: Bridgestone Sports Co., Ltd., Tokyo (JP)

(21) Appl. No.: 16/182,823

(22) Filed: Nov. 7, 2018

(30) Foreign Application Priority Data
Dec. 28, 2017 (JP) 2017-254451

(51) Int. Cl. A63B 37/00; C08G 18/42; C08G 18/44; C08G 18/73; C08L 75/06

(52) U.S. Cl. CPC A63B 37/0022; A63B 37/0031; A63B 37/0096; C08G 18/423; C08G 18/4236; A63B 2102/32; C08G 18/44; C08G 18/73; C08L 75/06; A63B 37/0076; A63B 37/0074; C08G 18/4202

(57) ABSTRACT

The present invention provides a golf ball capable of exhibiting an excellent spin performance in approach shot while the effect on the spin performance in driver shot is being suppressed to be low. The golf ball of the present invention includes a core, a cover located outside the core and having dimples formed thereon, and a coating layer located outside the cover and formed with a material having a surface force of −130 μN or less.

### CROSS-REFERENCE TO RELATED APPLICATION

This Application claims priority from Japanese Patent Application No. 2017-254451 filed Dec. 28, 2017, which is incorporated herein by reference in its entirety.

### BACKGROUND OF THE INVENTION

The present invention relates to a golf ball, and in particular, relates to a golf ball having excellent spin performance in an approach shot.

In a driver shot, it is generally demanded to decrease the spin rate after the shot, in order to further extend the flight distance. On the other hand, in an approach shot, for example, backspin is applied to the golf ball over a short flight distance, and accordingly, in general, the spin rate of the golf ball after a shot is demanded to be high.

Japanese Patent Application Publication No. 2014-524335 describes a golf ball provided with a soft outer surface coating, providing a high spin velocity and ability to control such a spin; having a hardness of 2B in terms of the ASTM D3363 scale or less than 35 in terms of the ASTM D2134 scale, by incorporating a low surface energy composition in order to maintain durability; and further having a surface energy less than 40 dyne/cm (40×10⁻³ N/m).

### SUMMARY OF THE INVENTION

As a method for exhibiting a high spin rate in an approach shot, it is possible to consider changes in the composition of the material for forming the coating layer located on the outermost surface of a golf ball. In the abovementioned Patent Literature, by softening the coating layer (the outer surface coating), the high spin in an approach shot is achieved, and even further higher spin in an approach shot is desired.

Accordingly, in view of the abovementioned problems, an object of the present invention is to provide a golf ball capable of exhibiting an excellent spin performance in an approach shot.

In order to achieve the abovementioned object, the golf ball according to the present invention includes a core, a cover located outside the core and having dimples formed thereon, and a coating layer formed with a material having a surface force of −130 μN or less.

The material for forming the coating layer may contain a low surface energy composition with a content of 1.0 part by weight or less in relation to 100 parts by weight of the resin component in the material forming the coating layer.

The cover may be formed with a material having a hardness of 60 or less in terms of the Shore D hardness.

The material forming the coating layer may have an elastic recovery rate of 70% or more. The thickness of the coating layer may be set to be 7 μm or more. The surface force of the material forming the coating layer may be set to be −200 μN or more.

By forming the coating layer of a golf ball in this way with a material having a surface force of −130 μN or less, a surface force lower than hitherto, it is possible to allow the spin rate of a golf ball to be higher than hitherto in an approach shot. The surface force of the material forming the coating layer significantly affects the spin rate of a golf ball after a shot in an approach shot in which swing is made so as to cut the surface of a golf ball with a face surface of the head of a golf club, and on the other hand, affects the spin rate in a driver shot to a very small extent; accordingly the abovementioned surface force can be effectively utilized for designing a golf ball capable exhibiting desired spin rate in each of an approach shot and a driver shot.

### BRIEF DESCRIPTION OF THE DRAWINGS

FIG. 1 is a cross-sectional view schematically illustrating an embodiment of the golf ball according to the present invention;

FIG. 2 is a schematic diagram illustrating a device for measuring the surface force of the golf ball according to the present invention; and

FIG. 3 is a schematic diagram illustrating a device for measuring the dynamic coefficient of friction of the golf ball according to the present invention.

### DESCRIPTION OF THE PREFERRED EMBODIMENTS

Hereinafter, an embodiment of the golf ball according to the present invention is described with reference to the accompanying drawings.

As shown in FIG. 1, the golf ball 1 of the present embodiment includes the core 10 located in the center of the ball, the cover 20 surrounding the outer circumference of the core 10, and the coating layer 30 surrounding the outside of the cover. On the surface of the cover 20, a plurality of dimples 22 are formed. The coating layer 30 covers the surface of the cover 20 in a substantially uniform thickness along the recesses of the dimples 22. It is to be noted that in the present embodiment, a golf ball having two-layer structure composed of the core and the cover is described, but the present invention is not limited to this, the golf ball may be a golf ball having an intermediate layer between the core 10 and the cover 20, a golf ball having a multilayer core composed of two or more layers, or a golf ball having a multilayer structure composed of three or more layers.

The core 10 can be formed mainly with a base material rubber. As the base material rubber, a wide variety of rubbers (thermosetting elastomers) can be used; for example, the following rubbers can be used, without being limited thereto: polybutadiene rubber (BR), styrene-butadiene rubber (SBR), natural rubber (NR), polyisoprene rubber (IR), polyurethane rubber (PU), butyl rubber (IIR), vinyl polybutadiene rubber (VBR), ethylene-propylene rubber (EPDM), nitrile rubber (NBR), and silicone rubber. As the polybutadiene rubber (BR), for example, 1,2-polybutadiene and cis-1,4-polybutadiene can be used.

To the core 10, in addition to the base material rubber to be a main component, for example, a co-cross-linking material, a cross-linking agent, a filler, an antiaging agent, an isomerization agent, a peptizer, sulfur, and an organosulfur compound can be optionally added. In addition, as the main component, in place of the base material rubber, a thermoplastic elastomer, an ionomer resin, or a mixture of these can also be used.

The core 10 substantially has a spherical shape. The upper limit of the outer diameter of the core 10 is preferably approximately 42 mm or less, more preferably approximately 41 mm or less, and further preferably approximately 40 mm or less. The lower limit of the outer diameter of the core 10 is preferably approximately 5 mm or more, more preferably approximately 15 mm or more, and most preferably approximately 25 mm or more. As the core 10, FIG. 1 shows a solid core, but the corer 10 is not limited to this, but may also be a hollow core. In addition, in FIG. 1, the core 10 is shown to have a single layer, but the core 10 is not limited to this and may be a core composed of a plurality of layers such as the center core and a layer surrounding the core.

As the method for molding the core 10, it is possible to adopt a heretofore known method for molding a core of a golf ball. For example, a core can be obtained by kneading a material containing a base material rubber with a kneading machine, and by pressure vulcanization molding of the resulting kneaded product with a round mold, although the method for obtaining a core is not limited to this. As a method for molding a core having a plurality of layers, it is possible to adopt a heretofore known method for molding a solid core having a multilayer structure. For example, a multilayer core can be obtained as follows: a center core is obtained by kneading materials with a kneading machine, and by pressure vulcanization molding of the resulting kneaded product with a round mold; then materials for a surrounding layer are kneaded with a kneading machine, and the resulting kneaded product is molded into a sheet shape to obtain a sheet for the surrounding layer; the center core is covered with the sheet to prepare a covered center core; then, the covered center core is subjected to a pressure vulcanization molding with the round mold to prepare a multilayer core.

The materials for forming the cover 20 are not limited to the following, but the cover 20 can be formed by using the following: thermoplastic polyurethane, ionomer resins, or the mixtures of these; in particular, from the viewpoint of the compatibility with the coating layer 30, it is preferable to use thermoplastic polyurethane.

The structure of the thermoplastic polyurethane material is composed of a soft segment composed of a polymer polyol (polymeric glycol) and a chain extender and polyisocyanate constituting the hard segment. Here, the polymer polyol to be a raw material is not particularly limited, but is preferably, in the present invention, a polyester-based polyol and a polyether-based polyol. Specific examples of the polyester-based polyol include: adipate-based polyols such as polyethylene adipate glycol, polypropylene adipate glycol, polybutadiene adipate glycol, and polyhexamethylene adipate glycol; and lactone-based polyols such as polycaprolactone polyol. Examples of the polyether polyol include poly(ethylene glycol), poly(propylene glycol), and poly(tetramethylene glycol).

The chain extender is not particularly limited; in the present invention, it is possible to use as a chain extender a low molecular weight compound having two or more active hydrogen atoms reactable with isocyanate groups in the molecule thereof, and having a molecular weight of 2,000 or less; in particular, an aliphatic diol having 2 to 12 carbon atoms. Specific examples of the chain extender may include 1,4-butylene glycol, 1,2-ethylene glycol, 1,3-butanediol, 1,6-hexanediol, and 2,2-dimethyl-1,3-propanediol; in particular, 1,4-butylene glycol is preferable.

The polyisocyanate compound is not particularly limited, but in the present invention, for example, it is possible to use one or two or more selected from the group consisting of 4,4′-diphenylmethane diisocyanate, 2,4-toluene diisocyanate, 2,6-toluene diisocyanate, p-phenylene diisocyanate, xylylene diisocyanate, naphthylene 1,5-diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, and dimeric acid diisocyanate. However, some isocyanate species make it difficult to control the cross-linking reaction during injection molding, and accordingly, in the present invention, 4,4′-diphenylmethane diisocyanate, an aromatic diisocyanate, is preferable from the viewpoint of the balance between the stability during production and the developed physical properties.

As the ionomer resin, it is possible to use a resin containing as the base resin(s) the following (a) component and/or the following (b) component, but the ionomer resin is not limited to this. In addition, to this base resin(s), the following (c) component can be added. The (a) component is an olefin-unsaturated carboxylic acid-unsaturated carboxylic acid ester ternary random copolymer and/or a metal salt thereof, the (b) component is an olefin-unsaturated carboxylic acid binary random copolymer and/or a metal salt thereof, and the (c) component is a thermoplastic block copolymer having a crystalline polyolefin block, and polyethylene/butylene random copolymer.

In addition, in the cover 20, in addition to the main component of the abovementioned thermoplastic polyurethane or ionomer resin, thermoplastic resins or elastomers other than the thermoplastic polyurethane can be mixed. Specifically, it is possible to use one or two or more of such thermoplastic resins or elastomers selected from polyester elastomer, polyamide elastomer, ionomer resin, styrene block elastomer, hydrogenated styrene butadiene rubber, styrene-ethylene/butylene-ethylene block copolymer or the modified products thereof, ethylene-ethylene/butylene-ethylene block copolymer or the modified product thereof, styrene-ethylene/butylene-styrene block copolymer or the modified product thereof, ABS resin, polyacetal, polyethylene and nylon resin. In particular, for example, because the resilience and the abrasion resistance are improved due to the reaction with the isocyanate group while the productivity is being satisfactorily maintained, it is suitable to adopt polyester elastomer, polyamide elastomer and polyacetal. When the abovementioned components are mixed, the mixing amounts thereof are appropriately selected, without being particularly limited, according to the regulation of the hardness, improvement of the resilience, the improvement of the fluidity, the improvement of the adhesiveness and the like of the cover material; however, the mixing amount(s) of the abovementioned component(s) can be set preferably to be 5 parts by weight or more in relation to 100 parts by weight of the thermoplastic polyurethane component. In addition, the upper limit of the mixing amount(s) is also not particularly limited, but can be set to be preferably 100 parts by weight or less, more preferably 75 parts by weight or less, and further preferably 50 parts by weight or less, in relation to 100 parts by weight of the thermoplastic polyurethane component. In addition, polyisocyanate compounds, fatty acids or the derivatives thereof, basic inorganic metal compounds, fillers and the like can also be added.

The lower limit of the thickness of the cover 20 is preferably approximately 0.2 mm or more and more preferably approximately 0.4 mm or more, without being limited to these values. In addition, the upper limit of the thickness of the cover 20 is preferably approximately 4 mm or less, more preferably approximately 3 mm or less, and further preferably approximately 2 mm or less. On the surface of the cover 20, a plurality of dimples 22 are formed. The size, shape and number of the dimples 22 can be appropriately designed according to the desired aerodynamic properties of the golf ball 1.

The upper limit of the hardness of the cover 20 is preferably approximately 60 or less, more preferably approximately 55 or less, and further preferably approximately 50 or less, in terms of the Shore D hardness, without being particularly limited to the values. The lower limit of the hardness of the cover 20 is preferably approximately 35 or more, and more preferably approximately 40 or more, in terms of the Shore D hardness. The hardness of the cover 20 is measured as follows: the resin material of the cover layer is molded into a sheet shape having a thickness of 2 mm, the resulting sheet is allowed to stand for 2 weeks or more, and the hardness of the sheet is measured as the Shore D hardness according to the ASTM D2240-95 specification.

As the method for forming the cover 20, a heretofore known method for forming a cover of a golf ball can be adopted. For example, the cover 20 is formed by injection molding the material for the cover in a mold, without being particularly limited to this. The molding for forming the cover has a cavity for molding the cover, and has a plurality of projections for forming the dimples on the wall surface of the cavity. By arranging the core 10 in the center of the cavity, the cover 20 is formed so as to cover the core 10.

Between the core 10 and the cover 20, an intermediate layer (not shown) may be optionally provided. An intermediate layer having a core-like function may be provided, or an intermediate layer having a cover-like function may be provided. In addition, a plurality of intermediate layers may also be provided; for example, a plurality of intermediate layers having a core-like or cover-like function may be provided, or a first intermediate layer having a core-like function and a second intermediate layer having a cover-like function may also be provided.

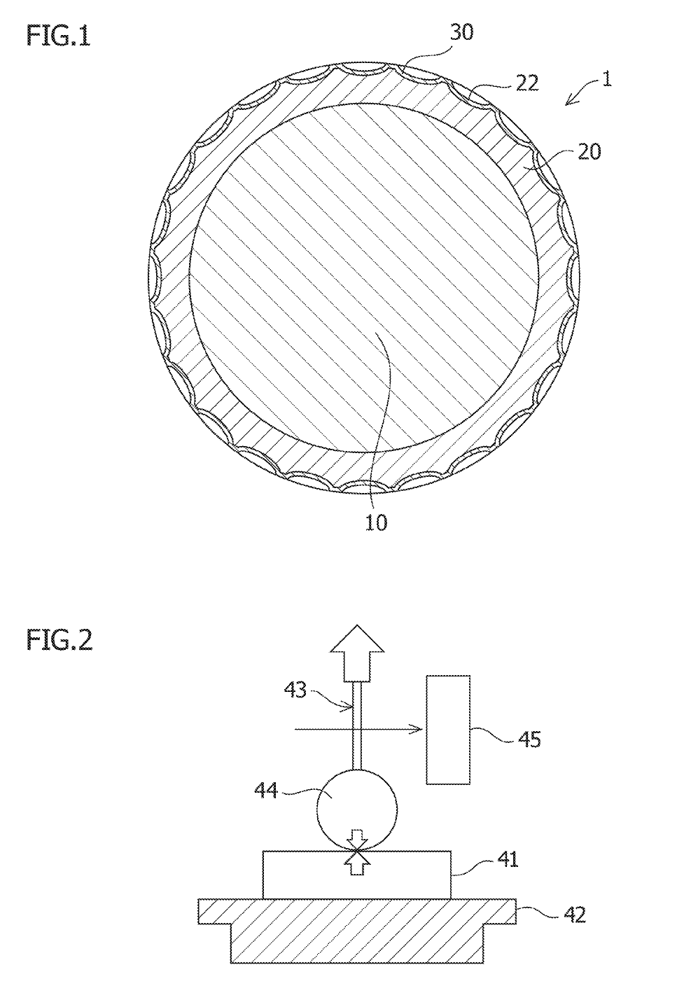

The coating layer 30 is formed from a material having a surface force lower than hitherto of −130 μN or less. The surface force is a force required for separating two material surfaces in contact with each other. The surface force can be measured with a surface force analyzer (trade name: ESP 5000 Plus) manufactured by Elionix Co., Ltd. The measurement of the surface force can be performed as follows: as shown in FIG. 2, after a spherical probe 44 fixed to the lowest end of a vertically displaceable gauge head 43 is brought into contact with the surface of a sample 41 of a material being a measurement object placed on a stage 42, a load is applied gradually so as for the gauge head 43 to displace upward, the displacement and load when the gauge head 44 is separated from the surface of the sample 41 are measured with a displacement meter 45 and a load meter (not shown), and thus the surface force can be measured. It is to be noted that by directly measuring a golf ball having a coating layer formed thereon, instead of such a sample as described above, with the abovementioned surface force analyzer, the surface force of the material of the coating layer can be measured. In this case, the land part between the dimples 22 of golf ball 1 is measured. The number of the samples is five, and the average value of the values of the five samples is taken as the surface force of the coating layer 30.

Because the coating layer 30 is formed from a material having a surface force of −130 μN or less, a surface force lower than hitherto, the adhesiveness of the coating layer 30 is increased, and it is possible to allow the spin rate of the golf ball to be higher than hitherto in approach shot. A preferable surface force is −140 μN or less. The lower limit of the surface force is not particularly limited, but is preferably −200 μN or more so that grime or the like does not tend to attach to the surface of the golf ball. It is to be noted that the surface force of the coating layer 30 significantly affects the spin rate of a golf ball after a shot in an approach shot in which swing is made so as to cut the surface of a golf ball with a face surface of the head of a golf club, and on the other hand, affects the spin rate in a driver shot to a very small extent; accordingly, the abovementioned surface force can be effectively utilized for designing a golf ball capable of exhibiting desired spin rate in each of an approach shot and a driver shot.

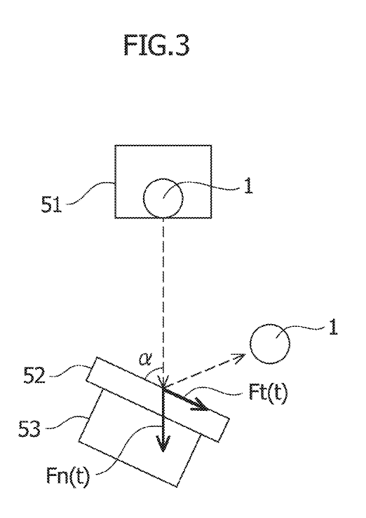

As an index similar to the surface force, a dynamic coefficient of friction may be mentioned. However, in a measurement method of the dynamic coefficient of friction, as shown in FIG. 3, the golf ball 1 is allowed to fall from a discharge device 51 at a height of 90 cm, and allowed to collide with a collision plate 52 arranged at an inclination angle α of 20° from the falling direction; the dynamic coefficient of friction at the time of collision is measured with a pressure sensor 53 fixed to the collision plate 52; the dynamic coefficient of friction is calculated on the basis of the following mathematical formula. In this way, the dynamic coefficient of friction is a parameter largely dependent on the constitution and the material of the cover 20 and the like, in addition to the coating layer 30 of the golf ball 1, and accordingly, the performance of the material forming the coating layer 30 cannot be evaluated on the basis of only the dynamic coefficient of friction.

Dynamic coefficient of friction=contact force in shear direction (Ft(t))/contact force in falling direction (Fn(t))

In addition, the material forming the coating layer 30 preferably has an elastic recovery rate of 70% or more. The elastic recovery rate is a value calculated by the following mathematical formula on the basis of the indentation work Welast (Nm) due to the return deformation of the material and the mechanical indentation work Wtotal (Nm).

Elastic recovery rate=Welast/Wtotal×100(%)

The elastic recovery rate can be measured with a nanoindentation hardness tester, ENT-2100 (trade name) manufactured by Elionix Co., Ltd. The elastic recovery rate is a microhardness testing method in which the indentation load is controlled in micro-Newton order (μN), the indenter depth at the time of indentation is traced with a precision of nanometer (nm), and the elastic recovery rate is a parameter of a nanoindentation method evaluating the physical properties of the coating layer 30. A conventional method was able to measure only the magnitude of the deformation trace (plastic deformation trace) corresponding to the maximum load; however, in the nanoindentation method, the relation between the indentation load and the indentation depth can be obtained by performing an automatic and continuous measurement. Accordingly, the nanoindentation method is free from the personal difference as in a conventional visual measurement of deformation trace with an optical microscope, and can evaluate highly precisely the physical properties of the coating layer. The elastic recovery rate is more preferably 80% or more. Because of having such a high elastic force, the self-repair function is high, the abrasion resistance is high as a coating material for a golf ball, and the performances of the golf ball can be maintained even after being hit a plurality of times.

As a material having such a surface force and such an elastic recovery rate, for example, coating material resins such as a urethane coating material composed of a polyol as a main agent and a polyisocyanate as a curing agent, and a rubber-based coating material can be used as the main component. In addition, the material for forming the coating layer 30 may include as an additive a low-surface energy composition such as a silicone wax in addition to the abovementioned main component. Hereinafter, the respective components are described.

As the polyol, without being limited to the following, a polycarbonate polyol or a polyester polyol is preferably used, and two types of polyester polyols, namely, a polyester polyol (A) and a polyester polyol (B) may also be used. In the case in which these two types of polyester polyols are used, these two types of polyester polyols are preferably different in the weight average molecular weight (Mw); the weight average molecular weight (Mw) of the (A) component is preferably 20,000 to 30,000, and the weight average molecular weight (Mw) of the (B) component is preferably 800 to 1,500. The weight average molecular weight (Mw) of the (A) component is more preferably 22,000 to 29,000, and further preferably 23,000 to 28,000. The weight average molecular weight (Mw) of the (B) component is preferably 900 to 1,200, and further preferably 1,000 to 1,100.

The polyester polyol is obtained by the polycondensation between a polyol and a polybasic acid. Examples of the polyol include: diols such as ethylene glycol, 1,2-propanediol, 1,3-propanediol, 1,3-butanediol, 1,4-butanediol, 1,6-hexanediol, neopentylglycol, diethylene glycol, dipropylene glycol, hexylene glycol, dimethylolheptane, polyethylene glycol, and polypropylene glycol; triols; tetraols, and polyols having an alicyclic structure. Examples of the polybasic acid include: aliphatic dicarboxylic acids such as succinic acid, adipic acid, sebacic acid, azelaic acid, and dimer acid; aliphatic unsaturated dicarboxylic acids such as fumaric acid, maleic acid, itaconic acid, and citraconic acid; aromatic polybasic carboxylic acids such as phthalic acid, isophthalic acid, terephthalic acid, trimellitic acid, and pyromellitic acid; dicarboxylic acids having alicyclic structure such as tetrahydrophthalic acid, hexahydrophthalic acid, 1,3-cyclohexanedicarboxylic acid, 1,4-cyclohexanedicarboxylic acid, and endomethylene tetrahydrophthalic acid; and tris-2-carboxyethyl isocyanurate. In particular, as the polyester polyol of the (A) component, polyester polyols having cyclic structure introduced into the resin skeleton can be adopted; examples of such a polyester polyol include a polyester polyol obtained by the polycondensation between a polyol having an alicyclic structure such as cyclohexane dimethanol, or a polyester polyol obtained by the polycondensation between a polyol having an alicyclic structure and diols or a triol and a polybasic acid. On the other hand, as the polyester polyol of the (B) component polyester, a polyester polyol having a multibranched structure can be adopted; examples of such a polyester polyol include: polyester polyols having a branched structure such as “NIPPOLAN 800” manufactured by Tosoh Corp.

In addition, when such a polyester polyol as described above is used, the weight average molecular weight (Mw) of the whole of the main agent is preferably 13,000 to 23,000, and more preferably 15,000 to 22,000. In addition, the number average molecular weight (Mn) of the whole of the main agent is preferably 1,100 to 2,000, and more preferably 1,300 to 1,850. When these average molecular weights (Mw and Mn) deviate from the abovementioned ranges, the abrasion resistance of the coating layer is liable to be decreased. It is to be noted that the weight average molecular weight (Mw) and the number average molecular weight (Mn) are the measured values (relative to polystyrene standards) on the basis of the gel permeation chromatography (hereinafter, abbreviated as GPC) measurement based on the differential refractive index meter detection. Even when two types of polyester polyols are used, the Mw and Mn of the whole of the main agent are within the abovementioned ranges.

The contents of the abovementioned two types of polyester polyols are not particularly limited; however, the content of the (A) component is preferably 20 to 30% by weight in relation to the total amount of the whole of the main agent inclusive of the solvent, and the content of the (B) component is preferably 2 to 18% by weight in relation to the total amount of the whole of the main agent.

The polyisocyanate is not particularly limited, but is any of the generally used aromatic, aliphatic, and alicyclic polyisocyanates and the like; specific examples of such a polyisocyanate include: trilene diisocyanate, diphenylmethane diisocyanate, xylylene diisocyanate, tetramethylene diisocyanate, hexamethylene diisocyanate, lysine diisocyanate, isophorone diisocyanate, 1,4-cyclohexylene diisocyanate, naphthalene diisocyanate, trimethylhexamethylene diisocyanate, dicyclohexylmethane diisocyanate, 1-isocyanato-3,3,5-trimethyl-4-isocyanatomethylcyclohexane. These can each be used alone, or as mixtures of two or more thereof.

Examples of the modified product of the abovementioned hexamethylene diisocyanate include polyester-modified products and urethane-modified products of hexamethylene diisocyanate. Examples of the derivative of the abovementioned hexamethylene diisocyanate include nurates (isocyanurates), biurets and adducts of hexamethylene diisocyanate.

In the urethane coating material composed of a polyol and a polyisocyanate as the main component, the lower limit of the molar ratio (NCO group/OH group) between the hydroxyl group (OH group) belonging to the polyol and the isocyanate group (NCO group) belonging to the polyisocyanate is preferably 0.6 or more and more preferably 0.65 or more. In addition, the upper limit of this molar ratio is preferably 1.5 or less, and more preferably 1.0 or less, and further preferably 0.9 or less. When this molar ratio is smaller than the abovementioned lower limit, unreacted hydroxyl groups remain, and the performance and the water resistance as the coating film for a golf ball are liable to be degraded. On the other hand, when this molar ratio exceeds the abovementioned upper limit, the isocyanate group is present excessively, and accordingly, the reaction between the isocyanate group and the water content produces the urea group (fragile), and consequently, the performance of the coating film for a golf ball is liable to be degraded.

As a curing catalyst (organometallic compound) promoting the reaction between the polyol and the polyisocyanate, an amine-based catalyst or an organometallic catalyst can be used; as the organometallic compounds, the compounds having hitherto been mixed as the curing agents of a two-component curing type urethane coating material, such as metal soaps of aluminum, nickel, zin, tin, and the like can be suitably used.

The polyol as a main agent and the polyisocyanate as a curing agent can be mixed with various types of organic solvents according to coating conditions. Examples of such an organic solvent include: aromatic solvent such as toluene, xylene, and ethyl benzene; ester-based solvents such as ethyl acetate, butyl acetate, propylene glycol methyl ether acetate, and propylene glycol methyl ether propionate; ketone-based solvents such as acetone, methyl ethyl ketone, methyl isobutyl ketone, and cyclohexanone; ether-based solvent such as diethylene glycol dimethyl ether, diethylene glycol diethyl ether, and dipropylene glycol dimethyl ether; alicyclic hydrocarbon-based solvent such as cyclohexane, methylcyclohexane, and ethylcyclohexane; and petroleum hydrocarbon-based solvents such as mineral spirit.

Examples of the low surface energy composition capable of being optionally contained as an additive in the material in addition to the main component include, without being limited to: modified or functionalized silicone and siloxane polymer, and fluoropolymer compounds. Examples of the silicone and the siloxane polymer include, without being limited to: polydimethylsiloxane, polymethylphenylsiloxane, polyethylphenylsiloxane, polymethylcyclohexylsiloxane, polymethylbutylcycloxane, polymethylethylcycloxane, polybutylphenylsiloxane, polydiphenylsiloxane, polymethylhexylsiloxane, and carbonyl-terminated siloxane. Examples of the fluoropolymer compound include, without being limited to: polytetrafluoroethylene (PTFE). Examples of the modified or functionalized siloxane polymer include: polysiloxane having organic groups introduced into the side chain or terminal of the polysiloxane skeleton; polysiloxane block copolymer or polysiloxane graft copolymer obtained by copolymerizing polysiloxane, acrylic polymer, polyether, polycaprolactone or the like; or polysiloxane obtained by introducing organic groups into the side chains or terminals of these polysiloxane block copolymers or polysiloxane graft copolymers. The polysiloxane skeleton, the polysiloxane block or the polysiloxane as the side chain is preferably of the straight-chain shape. Examples of the organic group may include a hydroxy group, an amino group, an epoxy group, a mercapto group, and a carbinol group. As such a low surface energy composition, for example, commercially available silicone waxes can be used.

The low surface energy composition is an optional component; for example, when a urethane coating material is used as the main component, the low surface energy composition is preferably used as added to the main agent. The low surface energy composition remains in the coating layer 30 formed by evaporation and removal of the organic solvent, and affects the coating layer 30 so as to enhance the surface force of the coating layer 30; accordingly, when the low surface energy composition is added, the amount of the low surface energy composition is preferably 1 part by weight or less, more preferably 0.5 part by weight or less, and further preferably 0.1 part by weight or less in relation to 100 parts by weight of the resin component constituting the coating layer 30.

To the material forming the coating layer 30, if necessary, heretofore known coating material ingredients may be further added. Specifically, a thickener, an ultraviolet absorber, a fluorescent whitening agent, a pigment, and the like can be mixed in appropriate amounts.

The thickness of the coating layer 30 is not particularly limited, but the lower limit of the thickness of the coating layer 30 is preferably 7 μm or more, more preferably 10 μm or more, and further preferably 13 μm or more. The upper limit of the thickness of the coating layer 30 is preferably 22 μm or less, and more preferably 20 μm or less. In FIG. 1, the coating layer 30 is represented as a single layer, but may be composed of two or more layers, without being limited to the case of FIG. 1. For example, when the coating layer has a two layer structure composed of the inner layer on the cover side and the outer layer on the outside of the cover, by forming the outer layer with the abovementioned material having a surface force, it is possible to obtain a desired spin rate in an approach shot.

The method for forming the coating layer 30 on the surface of the cover 20 is not particularly limited, and a heretofore known method of applying a golf ball coating material on the surface of the cover can be used, and methods such as an air gun coating method and an electrostatic coating method can be used.

The lower limit of the diameter of the golf ball 1 is 42.67 mm (1.68 inches) or more according to the rules, and the upper limit of the diameter of the golf ball 1 is preferably 44 mm or less, more preferably 43.5 mm or less, and further preferably 43 mm or less. The upper limit of the weight of the golf ball 1 is 45.93 g (1.620 ounces) or less according to the rules, and the lower limit of the weight of the golf ball 1 is preferably 44.5 g or more, more preferably 44.7 g or more, and further preferably 45.2 g or more.

### EXAMPLES

By using the coating layers shown in Table 1, the golf balls of Examples and Comparative Examples were prepared, and a test for measuring the spin performance in the approach shot of each of the golf balls was performed. The contents of the components in the main agent and the curing agent are given in mass percentages in the main agent and in the curing agent, respectively. It is to be noted that the structures and the materials of the cores and the intermediate layers of the golf balls were the same in all of Examples and Comparative Examples. With respect to the covers of the golf balls, the compositions of the materials were different from each other, but the structures of the covers were the same as each other.

TABLE 1

| | | | | | | | | | Comparative | |
|---|---|---|---|---|---|---|---|---|---|---|
| | | Examples | | | | | | | Examples | |
| | | 1 | 2 | 3 | 4 | 5 | 6 | 7 | 1 | 2 |
| Main | Polyol A | 27 | 21 | 27 | 24 | 21 | — | 27 | 27 | 27 |
| agent | Polyol B | — | 6 | — | 3 | 6 | — | — | — | — |
| | Polyol C | — | — | — | — | — | 30 | — | — | — |
| | Organic solvent | 73 | 73 | 73 | 73 | 73 | 70 | 73 | 73 | 73 |
| Curing | Isocyanate | 42 | 42 | 42 | 42 | 42 | 54 | 42 | 42 | 42 |
| agent | Organic solvent | 58 | 58 | 58 | 58 | 58 | 46 | 58 | 58 | 58 |
| Silicone wax | | 0.5 | 0.5 | — | — | — | — | 0.5 | 8 | 4 |
| Cover composition | | A | A | A | A | A | A | B | A | A |
| Elastic recovery rate (%) | | 60 | 80 | 60 | 70 | 80 | 80 | 60 | 60 | 60 |
| | Evaluation | Poor | Superior | Poor | Good | Superior | Superior | Poor | Poor | Poor |
| Surface force (μN) | | −130 | −130 | −140 | −140 | −140 | −180 | −130 | −110 | −120 |
| | Evaluation | Good | Good | Good | Good | Good | Superior | Good | Bad | Bad |
| Spin | Swing angle (°) | 31.3 | 30.0 | 29.3 | 28.6 | 27.6 | 26.6 | 31.9 | 33.0 | 32.1 |
| performance | Spin rate (rpm) | 5200 | 5350 | 5400 | 5500 | 5600 | 5845 | 5000 | 4800 | 4900 |
| | Evaluation | Good | Good | Good | Good | Good | Good | Good | Bad | Bad |

As the polyol A in the main agent in Table 1, the polyester polyol synthesized by the following method was used. In a reactor equipped with a reflux cooling tube, a dropping funnel, a gas introduction tube, and a thermometer, 140 parts by weight of trimethylolpropane, 95 parts by weight of ethylene glycol, 157 parts by weight of adipic acid 157, and 58 parts by weight of 1,4-cyclohexanedimethanol were placed, the resulting mixture was increased in temperature to 200 to 240° C. under stirring, and the mixture was heated (was allowed to react) for 5 hours. Then, a polyester polyol having an acid number of 4, a hydroxyl value of 170, and a weight average molecular weight (Mw) of 28,000 was obtained.

As the polyol B in the main agent in Table 1, NIPPOLAN 800 (trade name, weight average molecular weight (Mw): 1,000, solid content: 100%), a saturated aliphatic polyester polyol manufactured by Tosoh Corp. was used. Then, in each of Examples and Comparative Examples, the synthesized polyol A and the polyol B were dissolved in butyl acetate, as an organic solvent, so as to satisfy the mixing ratio in Table 1, and thus, the main agent was prepared.

The polyol C in the main agent in Table 1 was a polycarbonate polyol. As the polyol C, Tough Tex (trade name) manufactured by Cashew Co., Ltd., a urethane-based coating material combined with an isocyanate as a curing agent, was used. The main agent and the curing agent were mixed with each other in a ratio of 5:1.

As the isocyanate of the curing agent in Table 1, except for Example 7, nurate (isocyanurate) of hexamethylene diisocyanate (HMDI) of Duranate TPA-100 (trade name, NCO content: 23.1%, non-volatile content: 100%) manufactured by Asahi Kasei Corp. was used. In addition, the curing agent was prepared so as to satisfy the mixing ratio in Table 1 by using butyl acetate as an organic solvent.

As the silicone wax (low surface energy composition), BYK-SILCLEAN 3700 (trade name), an OH group-containing silicone-modified acrylic polymer, manufactured by BYK Chemie GmbH was used. The addition amount of the low surface energy composition is a value in relation to 100 parts by weight of the resin component in the material forming the coating layer.

As the composition of the cover, the composition A in Table 1 was composed of 100 parts by weight of T-8290 (trade name), a MDI-PTMG type thermoplastic polyurethane, PANDEX (registered trademark), manufactured by DICBayer Polymer Ltd., 1.0 part by weight of a polyethylene wax (trade name: Sunwax 161P, manufactured by Sanyo Chemical Industries, Ltd.), 6.3 parts by weight of 4,4′-diphenylmethane diisocyanate, as an isocyanate compound, and 3.3 parts by weight of titanium oxide (trade name: Tipaque R-550, manufactured by Ishihara Sangyo Kaisha, Ltd.). The material hardness was 41 in terms of the Shore D hardness.

As the composition of the cover, the composition B in Table 1 was composed of 75 parts by weight of T-8290 (trade name) and 25 parts by weight of T-8283 (trade name), each being a MDI-PTMG type thermoplastic polyurethane, PANDEX (registered trademark), manufactured by DICBayer Polymer Ltd., 11 parts by weight of Hytrel 4001 (trade name), a thermoplastic polyether ester elastomer, manufactured by Du Pont-Toray Co., Ltd., 3.9 parts by weight of titanium oxide (trade name: Tipaque R-550, manufactured by Ishihara Sangyo Kaisha, Ltd.), 1.2 parts by weight of a polyethylene wax (trade name: Sunwax 161P, manufactured by Sanyo Chemical Industries, Ltd.), and 7.5 parts by weight of 4,4′-diphenylmethane diisocyanate, as an isocyanate compound. The material hardness was 47 in terms of the Shore D hardness.

The composition of the intermediate layer was composed of 35 parts by weight of Himilan 1706 (trade name), 15 parts by weight of Himilan 1557 (trade name) and 50 parts by weight of Himilan 1605 (trade name), each being an ionomer resin of an ethylene-methacrylic acid copolymer manufactured by Du Pont-Mitsui Polychemicals Co., Ltd., and 1.1 parts by weight of trimethylol propane.

The composition of the core was composed of: 20 parts by weight of BR51 (trade name), a polybutadiene, manufactured by JSR Corp. and 80 parts by weight of BR-01 (trade name), a polybutadiene, manufactured by JSR Corp. as a base material rubber; 28.5 parts by weight of zinc acrylate (manufactured by Wako Pure Chemical Industries, Ltd.); 1.0 part by weight of dicumyl peroxide (trade name: PERCUMYL D, manufactured by NOF Corp.) as an organic peroxide; 0.1 part by weight of 2,2-methylenebis(4-methyl-6-butylphenol) (trade name: Nocrac NS-6, manufactured by Ouchi Shinko Chemical Industrial Co., Ltd.) as an antiaging agent; 33.0 parts by weight of barium sulfate (trade name: precipitated barium sulfate #100, manufactured by Sakai Chemical Industry Co., Ltd.); 4.0 parts by weight of zinc oxide (trade name: third grade zinc oxide, manufactured by Sakai Chemical Industry Co., Ltd.); and 0.5 part by weight of pentachlorothiophenol zinc salt (manufactured by Wako Pure Chemical Industries, Ltd.) as an organosulfur compound.

The surface force was measured with the abovementioned surface force analyzer (trade name: ESF-5000 Plus) manufactured by Elionix Co., Ltd. As the sample, a 15-μm-thick coating layer was used formed on the whole surface of a resin plate of diameter 30 mm and 5 mm in thickness. As probes, the following glass spheres were prepared: a silicone rubber made from PDMS as a raw material was applied on 1 mm diameter glass spheres constituted with a material Cr/PDMS/diameterl mm BK7, and further Cr was sputtered by ECR sputtering on the glass spheres to form an approximately 3-nm-thick film; and as probes, the glass spheres having a tip radius of curvature of 478 μm were used. The measurement conditions were as follows.
Spring constant: 75.755 N/m
Loading step: 1 μN/20 ms
Contact identification threshold: 20 nm/s (PZT elevation speed: 200 nm/s)
Number of measurement points: (3 points in X)×(3 points in Y)
Measurement interval: 200 μm

The elastic recovery rate was measured with theabovementioned nanoindentation hardness tester, ENT-2100 (trade name) manufactured by Elionix Co., Ltd. As the sample, used was a 50-μm-thick coating layer formed on the whole surface of a resin plate of diameter 30 mm and 5 mm in thickness. The measurement conditions were as follows.
Indenter: Berkovich indenter (material: diamond, angle α: 65.03°)
Load F: 0.2 mN
Loading time:10 seconds
Holding time: 1 second
Unloading time: 10 seconds

As the “spin performance” in Table 1, spin rates (rpm) were obtained by measuring a golf ball immediately after the swing with an initial condition measurement device when a sand wedge (trade name: “Tour Stage X-WEDGE,” manufactured by Bridgestone Sports Co., Ltd.) (loft: 56°) was mounted on a golf swing robot, and the golf ball was swung at a head speed of 20 m/s. The spin rate of 5000 rpm or more was marked with “Good”, and the spin rate of 4999 rpm or less was marked with “Bad”.

As shown in Table 1, in any of Examples 1 to 7 in each of which the coating layer was formed with a material having a surface force of −130 μN or less, the spin rate in an approach shot was 5000 rpm or more, and thus, a sufficient spin rate was able to be obtained. In particular, in each of Examples 3 to 5, it could be verified that when the coating layer was more softened by increasing the content of the polyol B, the spin rate in an approach shot was more increased. In addition, it could be verified that Example 7 in which the coating layer was formed in the same manner as in Example 1 was able to maintain the spin rate at 5000 rpm in an approach shot even when the hardness of the cover was made higher than the hardness of the cover in Example 1.

What is claimed is:

1. A golf ball comprising a core, a cover located outside the core and having dimples formed thereon, and a coating layer located outside the cover and formed with a material having a surface force of −130 μN or less.

2. The golf ball according to claim 1, wherein the material forming the coating layer contains a low surface energy composition in a content of 1.0 parts by weight or less in relation to 100 parts by weight of the resin component in the material forming the coating layer.

3. The golf ball according to claim 1, wherein the cover is formed of a material having a hardness of 60 or less in terms of the Shore D hardness.

4. The golf ball according to claim 1, wherein the material forming the coating layer has an elastic recovery rate of 70% or more.

5. The golf ball according to claim 1, wherein the thickness of the coating layer is 7 μm or more.

6. The golf ball according to claim 1, wherein the surface force of the material forming the coating layer is −200 μN or more.
